(19) United States
(12) Patent Application Publication
(10) Pub. No.: US 2005/0027534 A1
(43) Pub. Date: Feb. 3, 2005

(54) Phonetic and stroke input methods of Chinese characters and phrases

(76) Inventors: Pim van Meurs, Kenmore, WA (US); Lu Zhang, Bothell, WA (US)

Correspondence Address: GLENN PATENT GROUP, 3475 EDISON WAY, SUITE L, MENLO PARK, CA, 94025, US

(21) Appl. No.: 10/803,255

(22) Filed: Mar. 17, 2004

Related U.S. Application Data
(63) Continuation-in-part of application No. 10/631,543, filed on Jul. 30, 2003.

(51) Int. Cl. G10L 21/00

(52) U.S. Cl. 704/270

(57) ABSTRACT

A system and method for inputting Chinese characters using phonetic-based or stroke-based input method in a reduced keyboard is disclosed. By introducing common indices to ideographic characters, the system allows the ideographic characters to be shared among different type of input methods such as phonetic-based input method and stroke-based input method. The system matches input sequences to input method specific indices such as phonetic or stroke indices. These input method specific indices are then converted into indices to ideographic characters, which is then used to retrieve ideographic characters.

This is a Continuation-in-part application to the co-pending application, U.S. Ser. No. 10/631,543 filed on Jul. 30, 2003, entitled “SYSTEM AND METHOD FOR DISAMBIGUATING PHONETIC INPUT” (attorney docket number TEGI0012).

### BACKGROUND OF THE INVENTION

1. Technical Field

This invention relates generally to text entry technology. More particularly, the invention relates to a system and method for inputting Chinese characters and phrases.

2. Description of the Prior Art

For many years, the keyboard size has been a major size-limiting factor in the efforts to design and manufacture small portable computers because if standard typewriter-size keys are used, a portable computer must be at least as large as the keyboard. Although many kinds of miniaturized keyboards have been used in portable computers, they have been found too small to be easily or quickly manipulated by a regular user.

Incorporating a full-size keyboard in a portable computer also hinders true portable use of the computer. Most portable computers cannot be operated without placing the computer on a substantially flat work surface to allow the user to type with both hands. The user cannot easily use a portable computer while standing or moving. In the latest generation of small portable computers, called Personal Digital Assistants (PDAs) or palm-sized computers, manufacturers have attempted to address the problem by incorporating handwriting recognition software in the device. Users may directly enter text by writing on a touch-sensitive panel or screen. The handwritten text is then converted by the recognition software into digital data.

Unfortunately, in addition to the fact that printing or writing with a pen is usually slower than typing, the accuracy and speed of the handwriting recognition software has to date been less than satisfactory. In the case of Chinese language, with its large number of complex characters, the issue becomes especially complex. To make matters worse, today's handheld computing devices which require text input are becoming smaller still. Recent advances in two-way paging, cellular telephones, and other portable wireless technologies have led to a demand for small and portable two-way messaging systems, and especially for systems which can both send and receive electronic mail (“e-mail”).

Pinyin input method is one of the most commonly used Chinese character input method based on Pinyin, the official system of sounds forming syllables for Chinese language which was introduced in 1958 by the People's Republic of China. It is supplementary to the 5,000-year-old traditional Chinese writing system. Pinyin is used in many different ways. For examples: it is used as a pronunciation tool for language learners; it is used in index systems; and it is used for inputting Chinese characters into a computer. The Pinyin system adopts the standard Latin alphabets and takes the traditional Chinese analysis of the Chinese syllable into initials, finals (ending sounds) and tones.

Mandarin Chinese has consonant sounds that are found in most of the languages. For example, b, p, m, f, d, t, n, I, g, k, h are quite close to English. Other initial sounds, such as retroflex sounds zh, ch, sh and r, palatal sounds j, q and x, as well as dental sounds z, c and s, are different from English or Latin pronunciation. Table 1 lists all initial sounds according to the Pinyin system.

TABLE 1
Initial Sounds

| | | |
|---|---|---|
| Initial Sound | Pronunciation sample | Note |

Group I: Same pronunciation as in English

| | |
|---|---|
| M | Man |
| N | No |
| L | Letter |
| F | From |
| S | Sun |
| W | Woman |
| Y | Yes |

Group II: Slightly Different from English Pronunciation

| | | |
|---|---|---|
| P | Pun | use a strong puff of breath |
| K | Cola | use a strong puff of breath |
| T | Tongue | use a strong puff of breath |
| B | Bum | no puff of breath |
| D | Dung | no puff of breath |
| G | Good | no puff of breath |
| H | Hot | slightly more aspirated than in |
| | | English |

Group III: Different from English Pronunciation

| | | |
|---|---|---|
| ZH | Jeweler | |
| CH | | As in ZH but with a strong puff of |
| | | breath |
| SH | Shoe | |
| R | Run | |
| C | | Like “ts” in “it's high”, but with a |
| | | strong puff of breath |
| J | Jeff | |
| Q | | Close to “ch” in “Cheese” |
| X | | Close to “sh” in “sheep” |

The finals connect with the initial sounds to create a Pinyin syllable which corresponds to a Chinese character (zi: [symbol] ). A Chinese phrase (ci: [symbol] ) usually consists of two or more Chinese characters. Table 2 lists all the final sounds according to the Pinyin system and Table 3 gives some examples illustrating the combination of initials and finals.

TABLE 2
Final (ending) Sounds

| Final Sound | Pronunciation sample |
|---|---|
| a | As in father |
| an | Like the sounds of “Anne” |
| ang | Like the sound “an” with addition of “g” |
| ai | As in “high” |
| ao | As in “how” |
| ar | As in “bar” |
| o | Like “aw” |
| ou | Like the “ow” in “low” |
| ong | Like the “ung” in “jungle” with a slight “oo” sound |
| e | Sounds like “uh” |
| en | Like the “un” in “under” |
| eng | Like the “ung” in “lung” |
| ei | Like the “ei” in “eight” |
| er | Like the “er” in “herd” |
| i | Like the “i” in machine |
| in | As in “bin” |
| ing | Like “sing” |
| u | Like the “oo” in “loop” |
| un | As in “fun” |

TABLE 3
Putting Initials and Final (ending) Together

| Pinyin | Pronunciation sample |
|---|---|
| Ni | Like “knee” |
| Hao | Like “how” with a little more aspiration |
| Dong | Like “doong” |
| Qi | Like “Chee” |
| Gong | Like “Gung” |
| Tai | Like “Tie” |
| Ji | Like “Gee” |
| Quan | Like “Chwan” |

Each Pinyin pronunciation has one of the five tones (four pitched tones and a “toneless” tone) of Mandarin Chinese. A tone is important to the meaning of the word. The reason for having these tones is probably that Chinese language has very few possible syllables—approximately 400—while English has about 12,000. For this reason, there may be more homophonic words, i.e. words with the same sound expressing different meanings, in Chinese than in most other languages. Apparently tones help the relatively small number of syllables to multiply and thereby alleviate but not completely solve the problem. There is no paralleling concept of the tones in English. In English, an incorrect inflection of a sentence can render the sentence difficult to understand. But in Chinese an incorrect intonation of a single word can completely change its meaning. For example, the syllable “da” may represents several characters such as [symbol] in first tone (da1) meaning “to hang over something”, [symbol] in second tone (da2) meaning “to answer”, [symbol] in third tone (da3) meaning “to hit”, and [symbol] in fourth tone (da4) meaning “big”. The numbers after each of the syllables indicates the tones. The tones are also indicated by marks such as da d\acute{a}da dà. Table 4 shows a description of five tones for the syllable “da”.

TABLE 4
Five Tones

| Tone | Mark | Description |
|---|---|---|
| 1^{st} | da | High and level |
| 2^{nd} | dá | Starts medium in tone, then rises to the top |
| 3^{rd} | da | Starts low, dips to the bottom, then rises toward the |
| | | top |
| 4^{th} | dà | Starts at the top, then falls sharp and strong to the |
| | | bottom |
| Neutral | da | Flat, with no emphasis |

To enter a Chinese character using the Pinyin system, the user selects English letters corresponding to the character's Pinyin spelling. For example, on a standard QWERTY keyboard, when the user wants a Chinese character with a Pinyin of “ni”, he needs to press the “N” key and then the “I” key. After the “N” key and the “I” key are pressed, a list of Chinese characters associated with the Pinyin spelling “NI” is displayed. Then, the user selects the intended character from the list. This method is hereby referred as the basic Pinyin input method.

Five-stroke input method is another most commonly used method for inputting Chinese characters. Five-stroke is a shape-based input method which is based on the structure, or shape, of characters rather than on their pronunciation. The main concept behind five-stroke input method is that characters can be built by combining roots. Five-stroke method allots some 200 radicals, or roots, to five sections corresponding to five types of character strokes in the Chinese writing system: lateral, vertical, left sweep, dot/right sweep and bend.

In other words, the five-stroke input method divides the set of roots and the keyboard into five main categories according to the shape of the first stroke used to write each character. Each of the five roots is further divided into five levels. The resulting 25 root categories are assigned to the 25 keys A-Y on the keyboard.

The user needs no more than four keystrokes to enter any character in the code chart, and the most frequently used 600 characters require only one or two keystrokes. The user must know which radicals are assigned to each key, but once the array is memorized, the user can type quickly and accurately.

Since both the Pinyin input method and the five-strike input method are widely-used input methods for inputting Chinese characters and phrases, it is a common marketing requirement for a system to support both input methods. However, due to the difference of natural of phonetic-based input method and stroke-based input method, a different set of data will be required for each input method. The size of data is usually very large and at times it is usually difficult to support more than one set of data which are input method specific. This is especially true on capacity-limited devices such as reduced keyboard systems.

An effective reduced keyboard input system for Chinese language must satisfy all of the following criteria. First, the input method must be easy for a native speaker to understand and learn to use. Second, the system must tend to minimize the number of keystrokes required to enter text in order to enhance the efficiency of the reduced keyboard system. Third, the system must reduce the cognitive load on the user by reducing the amount of attention and decision-making required during the input process. Fourth, the approach should minimize the amount of memory and processing resources needed to implement a practical system.

In addition, the system should support both phonetic-based and stroke-based input methods on a reduced keyboard system. The system should share phonetic and stroke data to minimize the increase of data size so that the system only requires a little increase in storage capacity.

The basic Pinyin method can be applied to a reduced keyboard input system when combined with a non-ambiguous method of input Latin alphabets such as the multi-tap method. All non-ambiguous method, however, requires lots of key strokes, which is burdensome when combined with the basic Pinyin method. Thus it is preferable to combine the basic Pinyin method with a disambiguating system. One approach is developed to disambiguate only one Pinyin syllable at one time by requiring the user to select a delimiter key, such as key 1 or key 0, between Pinyin spellings that correspond to multiple Chinese characters in commonly known Chinese phrases ( [symbol] [symbol] , i.e. a word with more than one character). The selection of the delimiter key instructs the processor to search for Pinyin syllables that match the input sequence and for Chinese characters associated with the first Pinyin syllable which may be selected by default. As shown in FIG. 1, the user is trying to input the Chinese characters associated with the Pinyin spellings NI and Y. To do this, the user would first select the ‘6’ key 16, then the ‘4’ key 14. In order to instruct the processor to perform a search for a syllable matching the keys entered, the user then selects the delimiter key 10 and finally the ‘9’ key 19. Because this process requires a delimiter key depression between commonly linked multiple Chinese character words, time is wasted.

What is needed is a new technique for inputting Chinese using phonetic-based or stroke-based method in a reduced keyboard.

### SUMMARY OF THE INVENTION

A system and method for inputting Chinese characters using phonetic-based or stroke-based input method in a reduced keyboard is disclosed. By introducing common indices to ideographic characters, the system allows the ideographic characters to be shared among different type of input methods such as phonetic-based input method and stroke-based input method. The system matches input sequences to input method specific indices such as phonetic or stroke indices. These input method specific indices are then converted into indices to ideographic characters, which is then used to retrieve ideographic characters.

In one preferred embodiment, a method for input ideographic characters with a user input device is disclosed. The user input device includes: (1) a plurality of input means, each of which being associated with a plurality of strokes or phonetic characters, an input sequence being generated each time when an input is selected by the user input device; (2) data consisting of a plurality of input sequences and, associated with each input sequence, an input method specific database containing a plurality of input sequences and, associated with each input sequence, a set of phonetic sequences whose spellings correspond to the input sequence or a set of strokes sequences corresponding to the input sequence; and (3) an ideographic database containing a set of ideographic character sequences, wherein each ideographic character contains an ideographic index, a plurality of stroke indices to corresponding stroke sequences and a plurality of phonetic indices to corresponding phonetic sequences.

The method includes the steps of: entering an input sequence into a user input device; comparing the input sequence with the input method specific database and finding indices to matching strokes entries or phonetic entries and the matching stroke entries or phonetic entries; converting the matching indices to stroke entries or phonetic entries to matching ideographic indices; retrieving matching ideographic character sequences from the ideographic database by the matching ideographic indices; and optionally displaying one or more of the matched ideographic character sequences.

In another preferred embodiment, a system is disclosed for receiving input sequences entered by a user and generating textual output in Chinese language. The system includes: (1) a user input device having a plurality of input means, each of which being associated with a plurality of strokes or phonetic characters, an input sequence being generated each time when an input is selected by the user input device; (2) an input method specific database containing a plurality of input sequences and, associated with each input sequence, a set of phonetic sequences whose spellings correspond to the input sequence or a set of strokes sequences corresponding to the input sequence; (3) an ideographic database containing a set of ideographic character sequences, wherein each ideographic character contains an ideographic index, a plurality of stroke indices to corresponding stroke sequences and a plurality of phonetic indices to corresponding phonetic sequences; (4) means for comparing the input sequence with the input method specific database and finding indices to matching strokes entries or phonetic entries and the matching stroke entries or phonetic entries; (5) means for converting the matching indices to stroke entries or phonetic entries to matching ideographic indices; (6) means for retrieving matching ideographic character sequences from the ideographic database by the matching ideographic indices; and (7) an output device for displaying one or more matched stroke or phonetic entries, and matched ideographic characters.

### BRIEF DESCRIPTION OF THE DRAWINGS

FIG. 1 is schematic diagram showing a keyboard layout for inputting Chinese characters using delimiters between Pinyin syllables according to prior art;

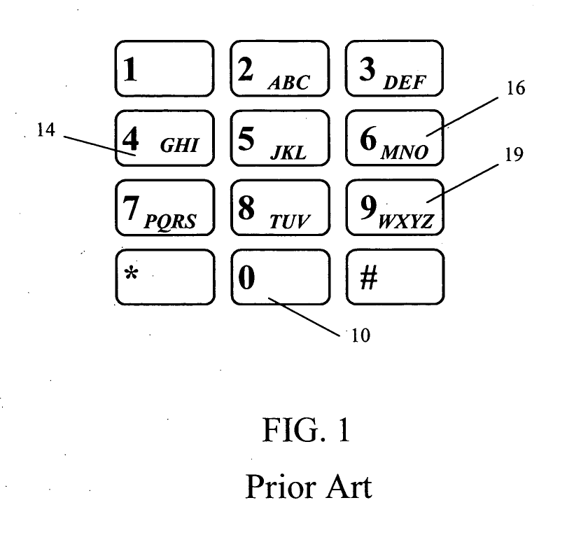

FIG. 2 is a schematic view of an exemplary embodiment of a cellular telephone which incorporates a phonetic input method to a reduced keyboard system according to the invention;

FIG. 3 is schematic diagram depicting an exemplary display where tones are used with Pinyin spelling during inputting Chinese phrases;

FIG. 4 is a block diagram illustrating the hardware components of the reduced keyboard system of FIG. 2;

FIG. 5 is a block diagram illustrating a system for supporting both phonetic-based and stroke-based input method for generating textual output in Chinese language according to one preferred embodiment of the invention;

FIG. 6 is a block diagram illustrating an ideographic language text input system incorporated in a user input device according to one preferred embodiment of the invention;

FIG. 7 is a flow diagram illustrating a method for generating textual output in Chinese language using the system in FIG. 5; and

FIG. 8 is a flow diagram illustrating a phonetic input method for generating textual output in Chinese language according to one preferred embodiment of the invention.

### DETAILED DESCRIPTION OF THE INVENTION

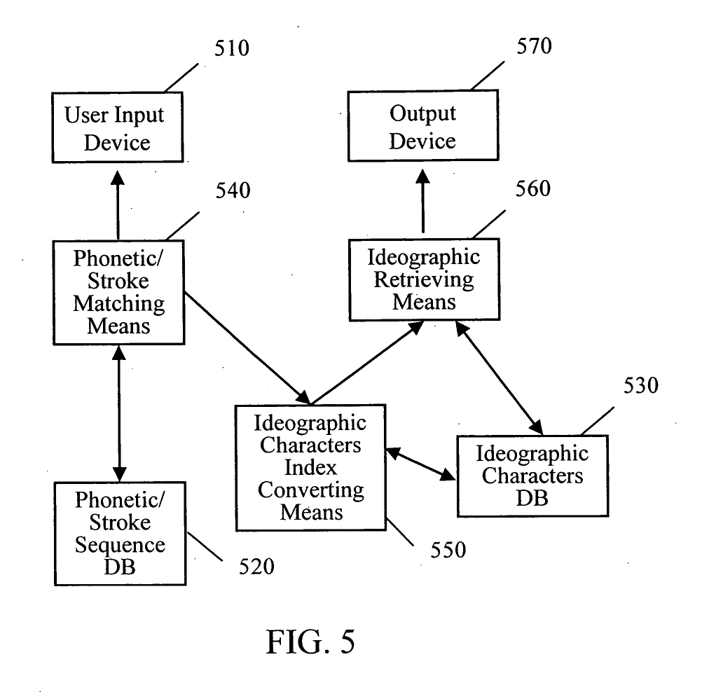

First referring to FIG. 5, which illustrates a system for supporting both phonetic-based and stroke-based input method is depicted for receiving input sequences entered by a user and generating textual output in Chinese language according to one preferred embodiment of the invention. The system includes the following:
a user input device 510 having a plurality of input means, wherein an input sequence is generated each time when an input is selected by the user input device;
a database 520 containing a plurality of input sequences and, associated with each input sequence, a set of phonetic sequences whose spellings correspond to the input sequence or a set of strokes sequences corresponding to the input sequence;
   Note that the stroke indices are typically indices of strokes sorted by stroke sequences in a stroke input system. The stroke input system can be a five-stroke or an eight-stroke system. The phonetic indices can be typically indices of phonetic characters sorted by actual spelling in a phonetic input system. The phonetic input system can be a Pinyin system or a Zhuyin system. Alternatively, the phonetic indices can be indices of input means in a phonetic input system.
a database 530 containing a set of ideographic character sequences, wherein each ideographic character contains an ideographic index, a plurality of stroke indices to corresponding stroke sequences and a plurality of phonetic indices to corresponding phonetic sequences;
   Note that by introducing the indices to ideographic characters, the system allows the ideographic characters to be shared among different type of input methods such as phonetic-based input method and stroke-based input method. The database 530 also contains information that is needed to convert between indices to ideographic characters and stroke indices, between indices to ideographic characters and phonetic indices, and from indices to ideographic characters to ideographic characters. These ideographic characters can be Unicode of GB code.
means for comparing the input sequence with the input method specific database and finding indices to matching strokes entries or phonetic entries and the matching stroke entries or phonetic entries 540;
means for converting the matching indices to stroke entries or phonetic entries to matching ideographic indices 550;
means for retrieving matching ideographic character sequences from the ideographic database by the matching ideographic indices 560; and
an output device 570 for displaying one or more matched phonetic entries and matched ideographic characters.

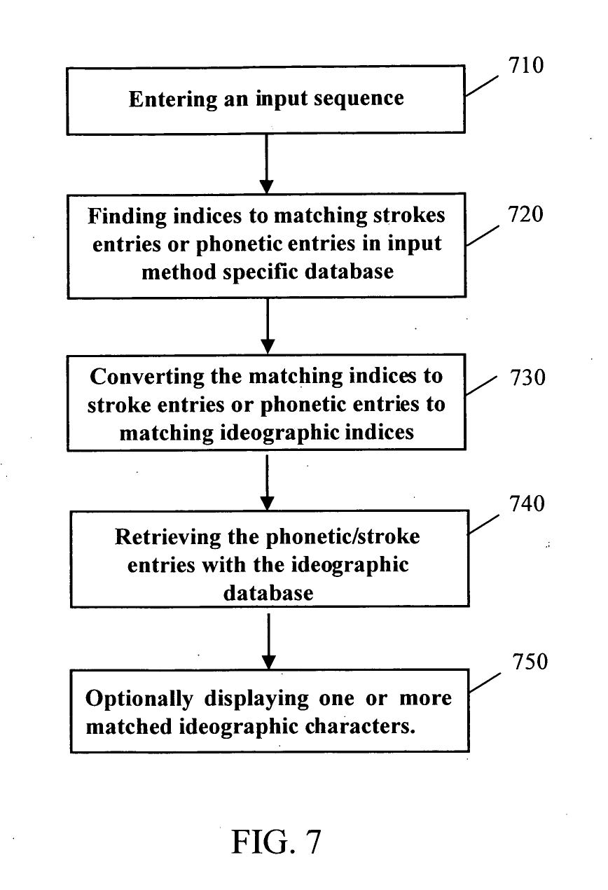

FIG. 7 illustrates a method for generating textual output in Chinese language using the system in FIG. 5 according to one preferred embodiment of the invention. The method includes the steps of:

Step 710: Enter an input sequence into user input device 510;

In this step, a user first generates an input sequence using the input means of the input device 510.

Step 720: Compare the input sequence with input method specific database 520 and find indices to matching strokes entries or phonetic entries and the matching stroke entries or phonetic entries;

In this step, based on the input method selected, the system uses the comparing and matching means 540 to find one or more indices to phonetic entries from the database 520, or one or more indices to stroke entries.

Step 730: Convert the matching indices to stroke entries or phonetic entries to matching ideographic indices;

In this step, the system uses the converting means 550 to convert the matched phonetic entries or stroke entries to indices to matching ideographic characters.

Step 740: Retrieve matching ideographic character sequences from the ideographic database by the matching ideographic indices; and

In this step, the indices to matching ideographic characters are passed to the retrieving means 560 to retrieve matching ideographic characters.

Step 750: Optionally display one or more of the matched ideographic character sequences.

In this step, the matched ideographic characters may be displayed on the output device 570. One of the matched ideographic characters, such as the one with highest FUBLM value, is selected by default. The user may accept the default or select a different matched ideographic sequence.

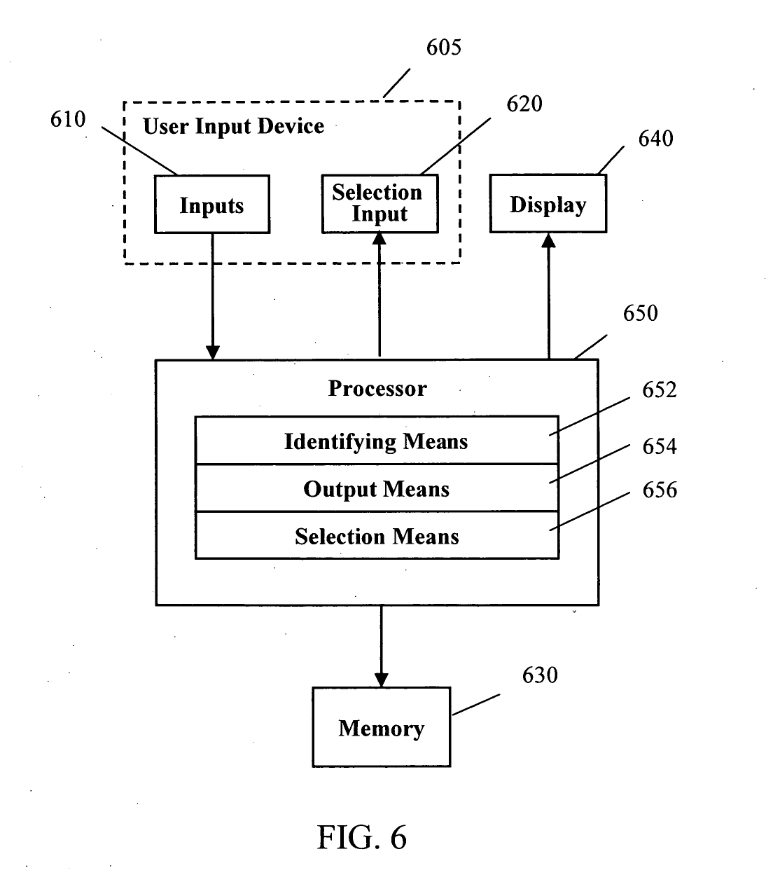

FIG. 6 illustrates an ideographic language text input system incorporated in a user input device according to one preferred embodiment of the invention. The system includes the following:
a plurality of inputs 610, each of which associated with a plurality of characters, an input sequence being generated each time when an input is selected by manipulating the user input device 605, wherein a generated input sequence corresponds to a sequence of inputs that have been selected;
at least one selection input 620 for generating an object output, wherein an input sequence is terminated when the user manipulates the user input device to a selection input;
a memory 630 containing a plurality of objects, wherein each of the plurality of objects is associated with an input sequence;
a display 640 to depict system output to the user; and
a processor 650 coupled to the user input device 605, memory 630, and display 640.

The processor 650 further includes: identifying means 652 for identifying from the plurality of objects in the memory any object associated with each generated input sequence; output means 654 for displaying on the display the character interpretation of any identified objects associated with each generated input sequence; and selection means 656 for selecting the desired character for entry into a text entry display location upon detecting the manipulation of the user input device to a selection input.

Once the user manipulates the user input device 605 and selects the inputs 610, an input sequence is generated. The processor 650 uses the identifying means 652 to match one or more linguistic objects from memory 630 with the generated input sequence. The character interpretation of the matched objects is output to the display 640 by the processor 650 using the output means 654. The user then selects a character interpretation with the selection input 620 and the processor 650 invokes the selection means 656 to output the selected character to a text entry display location.

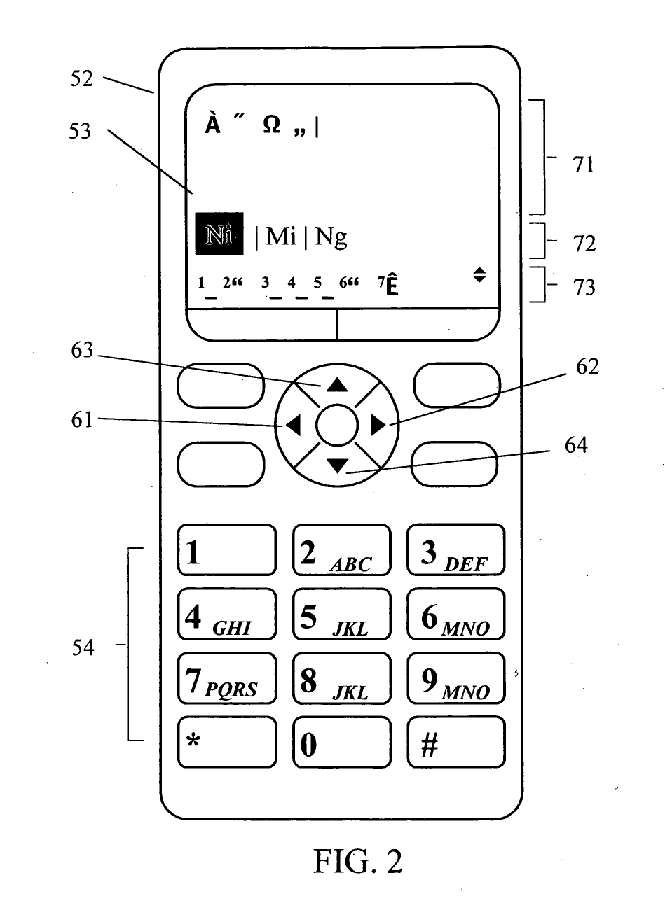

Now referring to FIG. 2, which is a schematic view of an exemplary embodiment of a cellular telephone that incorporates a phonetic input method to a reduced keyboard system according to the invention. The portable cellular telephone 52 has a display 53 and contains a reduced keyboard 54 implemented on the standard telephone keys. For the purposes of this invention, the term “keyboard” is defined broadly to include any input device including a touch screen having defined areas for keys, discrete mechanical keys, membrane keys, and the like. The arrangement of the Latin alphabets on each key in the keyboard 54 is corresponding to what has become a de facto standard for American telephones. Note that keyboard 54 thus has a reduced number of data entry keys as compared to a standard QWERTY keyboard, where one key is assigned for each Latin alphabet. More specifically, the preferred keyboard shown in this embodiment contains ten data keys numbered ‘1’ through ‘0’ arranged in a 3-by-4 array, together with four navigation keys comprising of Left Arrow 61 and Right Arrow 62, Up Arrow 63 and Down Arrow 64.

The user enters data via keystrokes on the reduced keyboard 54. In the first preferred embodiment, when the user enters a keystroke sequence using the keyboard, text is displayed on the telephone display 53. Three regions are defined on the display 53 to display information to the user. A text region 71 displays the text entered by the user, serving as a buffer for text input and editing. A phonetic, e.g. Pinyin, spelling selection list 72, typically located below the text region 71, shows a list of Pinyin interpretations corresponding to the keystroke sequence entered by the user. A phrase selection list region 73, e.g. Chinese phrases, typically located below the spelling selection list 72, shows a list of words corresponding to the selected Pinyin spelling, which is corresponding to the sequence entered by the user. The Pinyin selection list region 72 aids the user in resolving the ambiguity in the entered keystrokes by simultaneously showing both the most frequently occurring Pinyin interpretation of the input keystroke sequence and other less frequently occurring alternate Pinyin interpretations displayed in descending order of FUBLM. The Chinese phrase selection list region 73 aids the user in resolving the ambiguity in the selected Pinyin spelling by simultaneously showing both the most frequently occurring Phrase text of the selected spelling and other less frequently occurring Phrase text displayed in descending order of frequency of user base on a linguistic model (FUBLM). While Pinyin is described herein as comprising a phonetic input, it should be appreciated that phonetic inputs may comprise Latin alphabet; Bopomofo alphabet also known as Zhuyin; digits; and punctuation.

In order to present the user with possible phrases, the system relies on a linguistic model which can be limited to words found exactly in a database ordered alphabetically or according to total number of keystroke in ideographs, radicals of ideographs or a combination of both. The linguistic model can be extended to order linguistic objects according to a certain fixed frequency of common usage such as in formal or conversational, written or conversational spoken text. Additionally, the linguistic model can be extended to use N-gram data to order particular characters. The linguistic model can even be extended to use grammatical information and transition frequencies between grammatical entities to generate phrases which go beyond those phrases included in the database. Thus the linguistic model may be as simple as a fixed frequency of use and a fixed number of phrases, or include adaptive frequency of use, adaptive words or even involve grammatical/semantic models which can generate phrases that go beyond those contained in the database.

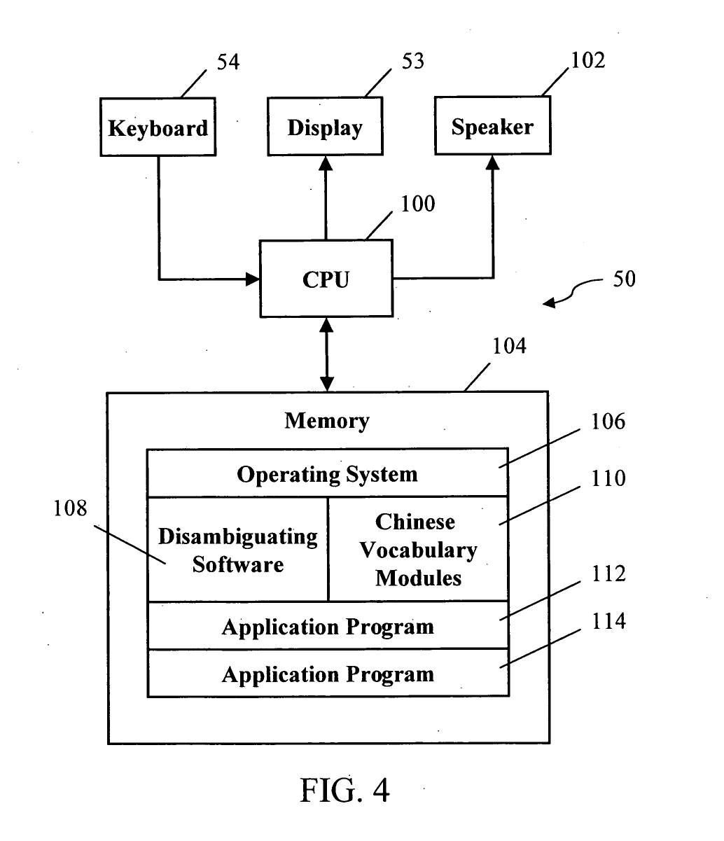

Referring to FIG. 4, which schematically depicts the hardware components of the reduced keyboard system of FIG. 2, the keyboard 54 and the display 53 are coupled to a processor 100 through appropriate interfacing circuitry. Optionally, a speaker 102 is also coupled to the processor 100. The processor 100 receives input from the keyboard 54, and manages all output to the display 53 and speaker 102. Processor 100 is coupled to a memory 104. The memory 104 includes a combination of a temporary storage media, such as random access memory (RAM), and a permanent storage media, such as read-only memory (ROM), floppy disks, hard disks, or CD-ROMs. Memory 104 contains all software routines to govern system operation. Preferably, the memory 104 contains an operating system 106, disambiguating software 108, and associated vocabulary modules 110 which are discussed above. Optionally, the memory 104 may contain one or more application programs 112, 114. Examples of the application programs include word processors, software dictionaries, and foreign language translators. Speech synthesis software may also be provided as an application program which allows the reduced keyboard disambiguating system to function as a communication aid.

Referring back to FIG. 2, the reduced keyboard system allows a user to quickly enter text or other data using only a single hand. The user enters data using the reduced keyboard 54. Each of the data keys 2 through 9 has multiple meanings, represented on the top of the key by Latin alphabets, numbers, and other symbols. Because individual keys have multiple meanings, keystroke sequences are ambiguous as to their meaning. When the user enters data, the various keystroke interpretations are therefore displayed in multiple regions on the display 53 to aid the user in resolving any ambiguity. On large-screen devices, a Pinyin selection list of possible interpretations of the entered keystrokes and a Chinese phrase selection list of the selected Pinyin spelling are displayed to the user in the selection list regions. The first entry in the Pinyin selection list is selected as a default interpretation and highlighted in any way to distinguish itself from the other Pinyin entries in the selection list. In the preferred embodiment, the selection Pinyin entry is displayed in reverse color image such as white font with a dark background.

The Pinyin selection list of the possible interpretations of the entered keystrokes may be ordered in a number of ways. In a normal mode of operation, the keystrokes are initially interpreted as a Pinyin spelling consisting of complete Pinyin syllables corresponding to a desired Chinese phrase (hereinafter as complete Pinyin interpretation). As keys are entered, a vocabulary module look-up is simultaneously performed to locate valid Pinyin spellings corresponding to the input key sequence. The Pinyin spellings are returned from the vocabulary module according to FUBLM, with the most commonly used Pinyin spelling listed first and selected by default. The Chinese phrases matching the selected Pinyin spelling are also returned from the vocabulary module according to FUBLM. Normally the user can find the Chinese phrase he wants to input in the Chinese phrase select list and then select the Chinese phrase and input the Chinese phrase in the text input region 71. If the default selected Pinyin spelling is what the user wants to input, but the Chinese phrase he wants to input is not displayed, he can use the Up Arrow 63 and Down Arrow 64 keys to display an extended set of other matched Chinese phrases from the vocabulary database. In a few cases, the Pinyin selection list region 72 cannot hold all matched Pinyin spellings, and thus the Left Arrow 61 and Right Arrow 62 keys are used to scroll the previously off-screen Pinyin spellings into the Pinyin select list region 72. For example, if the default selected Pinyin spelling is not what the user wants to input, he can use the Left Arrow 63 and Right Arrow 64 keys to select other matched Pinyin spellings.

In the majority of text entry, keystroke sequences are intended by the user to spell out complete Pinyin syllables. It is appreciated, however, that the multiple characters associated with each key allow the individual keystrokes and keystroke sequences to have several interpretations. In the preferred reduced keyboard disambiguating system, various different interpretations are automatically determined and displayed to the user as a list of Pinyin spellings and a list of Chinese phrases corresponding to the selected Pinyin spellings.

For example, the keystroke sequence is interpreted in terms of partial Pinyin spelling corresponding to possible Chinese phrases that the user may be entering (thereinafter as partial Pinyin interpretation). Unlike complete Pinyin interpretation, partial Pinyin spelling allows the last Pinyin syllable to be incomplete. A Chinese phrase is returned from the vocabulary database if its Pinyin for the characters before the last character matches all syllables before the last partial Pinyin syllable while the Pinyin syllable of the last character starts with the partially completed syllable. By returning Chinese phrases that match a Pinyin spelling that extends the original partial phrasal Pinyin with a possible completion of the last Pinyin syllable, the partial Pinyin interpretation allows the user to easily confirm that the correct keystrokes have been entered, or to resume typing when his attention has been diverted in the middle of the phrase. The partial Pinyin interpretation is therefore provided as entries in the Pinyin spelling list. Preferably, the partial Pinyin interpretations are sorted according to the composite FUBLM of the set of all possible Chinese phrases that can match a Pinyin spelling that extends the partial Pinyin input with a possible completion of the last Pinyin syllable. Partial Pinyin interpretations provide feedback to the user by confirming that the correct keystrokes have been entered to lead to the entry of the desired word.

To reduce the number of possible matches displayed, the user may also input a syllable delimiter after a completed Pinyin syllable. In one preferred embodiment, the ‘0’ key is used as a syllable delimiter. If syllable delimiters are entered, only Pinyin spellings whose syllable ending matches the position of syllable delimiters are returned and displayed in the Pinyin selection list region 72.

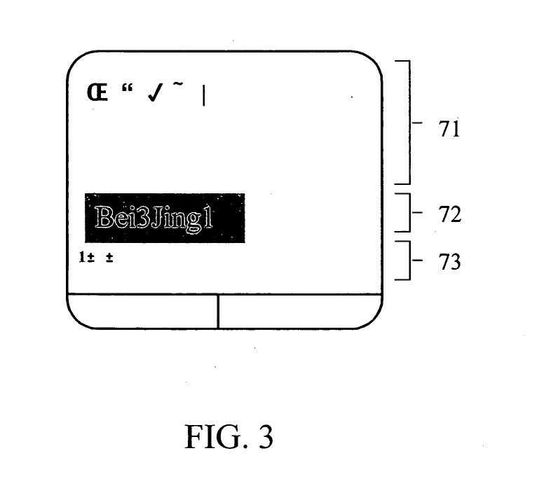

In another preferred embodiment, the user may also input a tone after each completed Pinyin syllable. After each completed Pinyin syllable, the user presses a tone key followed a number which corresponding to the tone of the syllable. In this preferred embodiment, the ‘1’ key is used as the tone key. If tones are entered, only Pinyin spellings having Chinese phrases conversions that match the tones are returned and displayed in the Pinyin selection list region 72. The displayed Pinyin spellings also include the tones that have been entered. As shown in FIG. 3, the Pinyin spelling “Bei3Jing1” is displayed in the Pinyin spelling list region 72. If a Pinyin spelling with tones has been selected, only Chinese phrases that match both the Pinyin spelling and the corresponding tones are returned and displayed. The filtering may be applied to tones following a complete Pinyin syllable or a partial Pinyin spelling.

The partial Pinyin completion looks ahead until the last syllable is complete. There are maximum five nodes in the second section of the path because the longest syllable is “Chuang” or “Shuang” or Zhuang”. Only in these three cases, the process looks ahead five more nodes.

For instance, if the key input is “2345”, one of the valid spellings is “BeiJ”. The first complete syllable is “Bei”. The second is “J” that is not a complete syllable. Thus, the first section of the path for this case is to build the spelling “BeiJ”. The process will look ahead in the vocabulary module tree to complete the last syllable. Then, it finds the word (BeiJing) that has partial spelling matches “BeiJ”. The second section of the path is used to build “ing”. If the word “BeiJingShi” is also in the vocabulary module tree, the process would not locate this word for the key input “2345” because it requires looking ahead two more syllables.

If any tone is entered, the process can filter the characters because the character tones are retrieved along with their Unicodes when secondary instructions are executed. If a character has more than one pronunciation, the most common one is retrieved first.

The conversions (characters and words) for each spelling are prioritized by the FUBLM. The most frequently used character or word is retrieved first during the spelling-character/word conversion. The words converted from the exactly matched spelling are ordered ahead of the words converted from the partial matched spellings. The words converted from the different partial matched spellings are sorted by the key order (that is, key 2, 3, 4, 5 . . . ) and the frequency order of the letters on the key (character on the key index). For example, assuming the active spelling is “Sha”, because ‘n’ is ordered ahead of ‘o’ when the previous letter is ‘a’, the characters converted from the “Sha” are returned first, followed by these converted from “Shai”, “Shan”, “Shang” and “Shao”.

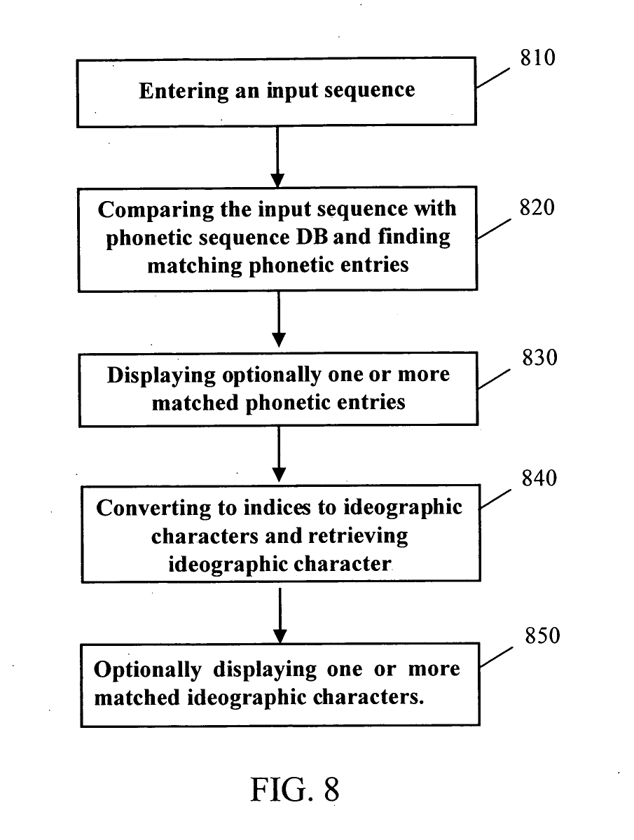

FIG. 8 illustrates a phonetic input method for generating textual output in Chinese language according to one preferred embodiment of the invention. The method includes the steps of:

Step 810: Enter an input sequence into a user input device;

Step 820: Compare the input sequence with the phonetic sequence database and find matching phonetic entries and their indices;

Step 830: Display optionally one or more matched phonetic entries;

Step 840: Convert “indices to phonetic entries” to “indices to ideographic characters” and retrieve matching ideographic characters from the ideographic database by the indices to ideographic characters; and

Step 850: Optionally display one or more matched ideographic characters.

In another preferred embodiment, the disambiguating Pinyin system allows spelling variations which are typically caused by regional accents. Regional accents can lead to variations in pronunciations for various syllables. This can lead to confusion about for instance “zh-” and z-”, “-n” and “-ng.” To accommodate these variations, variations on certain spellings can be considered. Variations can either be displayed as part of the selection list for the particular Pinyin, for instance if the user types “zan” the selection list may include “zhan” and “zhang” as possible variants, or the user when failing to find a particular character may select a “show variants” options which will provide the user with possible variations of the spelling. Additionally the user may be able to turn off and on particular “confusion sets” such as “z<->zh”, “an<->ang” etc.

TABLE 5
Examples of Common Confusion Sets

| | |
|---|---|
| A | Ia |
| E | IE |
| O | Ou, uo |
| An | Ang, ian, iang |
| En | Eng |
| In | Ing |
| Ong | Iong |
| Uan | Uang |
| On | Ong, iong |
| Ao | Iao |
| Z | Zh |
| C | Ch |
| S | Sh |
| L | N |

In another preferred embodiment, the disambiguating system includes a custom word dictionary. Since the dictionary of phrases is limited by the available memory, the custom word dictionary is essential that the user can add Pinyin/character combinations manually which can then be accessed via the input method.

In another preferred embodiment, the disambiguating Pinyin system may update the FUBLM adaptively based on the recency of use. The initial phrases are ordered according to a particular linguistic model (for instance the frequency of use in a corpus) which may not match the user's expectations. By tracking the user's patterns, the system will learn and update the linguistic model accordingly.

In another preferred embodiment, the system may provide the user with word predictions based on the words syllables entered so far and a linguistic model. The linguistic model may be used to determine in which order the predictions should be presented to the user. In fact the linguistic model can provide the user with predictions of words even before the user types any characters. Such a linguistic model may be based on simple frequency of use of single characters, or frequency of use of two or more character combinations (N-grams) or a grammatical model or even a semantic model. In alternative embodiments, the number of total keystrokes in an ideograph; radical of an ideograph; radical and number of strokes of a radical; alphabetically ordered; frequency of occurrence of ideograph sequences or phonetic sequences in formal, conversational written, or conversational spoken text; frequency of occurrence of ideographic sequences or phonetic sequences when following a preceding character or characters; proper or common grammar of the surrounding sentence; application context of current input sequence entry; and recency of use or repeated use of phonetic or ideographic sequences by the user or within an application program.

While the preferred input method would require the user to enter the full spelling of the word, the user may select to enter only the first character of each syllable. Thus instead of typing BeiJing, the user type BJ and is provided with phrases that match this acronym. Additionally, the user may define their own acronyms and add them to the Custom word dictionary.

In addition to ambiguous entry of characters, the system may also provide a non-ambiguous method for the user to explicitly select a character.

During the input process, the user may enter partial syllables for each of the multiple syllable words. Preferably, the number of partial keystrokes for each syllable is one, for example, the first keystroke of each syllable.

The system may also display the valid final sounds after the user identifies the initial sound. For example, if a user is trying to input Pinyin syllable “Zhang”, the user first identifies the initial sound “zh” and then is provided with valid final sounds for the initial for which the user may select “ang”.

During the input process, the user may also select one of the many inputs associated with a special wildcard input. The special wildcard input may match zero or one of phonetic characters.

The system may also display phonetic sequences that include matching entries in English or other alphabetic languages and allow simultaneous interpretation of the key presses as syllables and words in a secondary language such as English.

As is shown by the above detailed description, a system has been designed to create an effective reduced keyboard input system for Chinese language. First, the method is easy for a native speaker to understand and learn how to use because it is based on the official Pinyin system. Second, the system tends to minimize the number of keystrokes required to enter text. Third, the system reduces the cognitive load on the user by reducing the amount of attention and decision-making required during the input process and by the provision of appropriate feedback. Fourth, the approach disclosed herein tends to minimize the amount of memory and processing resources required to implement a practical system.

Those skilled in the art will also recognize that minor changes can be made to the design of the keyboard arrangement and the underlying database design, without significantly departing from the underlying principles of the current invention.

Accordingly, the invention should only be limited by the Claims included below.

1. A method for input ideographic characters comprising the steps of:
(a) entering an input sequence into a user input device;
wherein said user input device comprises:
a plurality of input means, each of said input means being associated with a plurality of strokes or phonetic characters, and an input sequence being generated each time when an input is selected by said user input device;
data consisting of a plurality of input sequences and, associated with each input sequence, an input method specific database containing a plurality of input sequences and, associated with each input sequence, a set of phonetic sequences whose spellings correspond to the input sequence or a set of strokes sequences corresponding to the input sequence; and
an ideographic database containing a set of ideographic character sequences, wherein each ideographic character contains an ideographic index, a plurality of stroke indices to corresponding stroke sequences and a plurality of phonetic indices to corresponding phonetic sequences;
(b) comparing the input sequence with said input method specific database and finding indices to matching strokes entries or phonetic entries and said matching stroke entries or phonetic entries;
(c) converting said matching indices to stroke entries or phonetic entries to matching ideographic indices;
(d) retrieving matching ideographic character sequences from said ideographic database by said matching ideographic indices; and
(e) optionally displaying one or more of said matched ideographic character sequences.

2. The method of claim 1, wherein said stroke indices are indices of strokes sorted by stroke sequences in a stroke input system.

3. The method of claim 2, wherein said stroke input system is a five-stroke or an eight-stroke system.

4. The method of claim 1, wherein said phonetic indices are indices of phonetic characters sorted by actual spelling in a phonetic input system.

5. The method of claim 4, wherein said phonetic input system is a Pinyin system or a Zhuyin system.

6. The method of claim 1, wherein said phonetic indices are indices of input means in a phonetic input system.

7. The method of claim 1, further comprising the step of:
prioritizing stroke or phonetic sequences that match an input sequence and prioritizing ideographic character sequences that match a stroke or phonetic sequence according to a linguistic model.

8. The method of claim 7, wherein said linguistic model comprises at least one of:
number of total keystrokes in an ideograph;
radical of an ideograph;
radical and number of strokes of a radical;
alphabetical order;
frequency of occurrence of ideographic character sequences, stroke sequences or phonetic sequences in formal, conversational written, or conversational spoken text;
frequency of occurrence of ideographic character sequences, stroke sequences or phonetic sequences when following a preceding character or characters;
grammar of the surrounding sentence;
application context of current input sequence entry; and
recency of use or repeated use of stroke, phonetic or ideographic character sequences by the user or within an application program.

9. The method of claim 1, wherein said phonetic sequences comprise single syllables.

10. The method of claim 1, wherein said phonetic sequences comprise single and multiple syllables.

11. The method of claim 1, wherein said phonetic sequences comprise user generated sequences.

12. The method of claim 11, wherein in absence of matching phonetic sequences in said database, a sequence of matching phonetic sequences is automatically generated based on single and optionally multiple syllable phonetic sequences.

13. The method of claim 12, wherein said sequence of matching phonetic sequences is narrowed down through user interaction.

14. The method of claim 12, wherein a sequence of matching ideographic character sequences is automatically generated based on matching phonetic sequences to ideographic character sequences.

15. The method of claim 14, wherein a sequence of matching ideographic character sequences is narrowed down through user interaction.

16. The method of claim 7, further comprising the step of:
once an ideographic character sequence is selected, changing the associated priority of said matching phonetic sequence and sequence of ideographic characters.

17. The method of claim 1, wherein the user can specify an explicit ideographic character separator.

18. The method of claim 1, further comprising the step of:
when the user enters a sequence of phonetic characters, returning a sequence of phonetic sequences of exact matches and predictions that partially match.

19. The method of claim 18, wherein said sequence of phonetic sequences is ordered according to a linguistic model.

20. The method of claim 19, wherein said linguistic model comprises at least one of:
alphabetical order;
frequency of occurrence of phonetic sequences or ideographic character sequences in formal or conversational written text;
frequency of occurrence of phonetic sequences or ideographic when following a preceding character or characters;
grammar of the surrounding sentence;
application context of current character sequence entry; and
recency of use or repeated use of phonetic sequences by the user or within an application program.

21. The method of claim 1, further comprising the step of:
once the user has selected a sequence of ideographic characters, presenting the user with a list of sequences of one or more ideographic characters.

22. The method of claim 21, wherein said list of sequences is ordered according to a linguistic model.

23. The method of claim 22, wherein said linguistic model comprises at least one of:
number of total keystrokes in an ideograph;
radical of an ideograph;
radical and number of strokes of radical;
alphabetical order;
frequency of occurrence of ideographic characters in formal or conversational written text;
frequency of occurrence of ideographic characters when following a preceding character or characters;
grammar of the surrounding sentence;
application context of current character entry; and
recency of use or repeated use of ideographic characters by the user or within an application program.

24. The method of claim 1, wherein the user can enter partial syllables for each of the multiple syllable words.

25. The method of claim 24, wherein the number of partial keystrokes for each syllable is one.

26. The method of claim 1, wherein one of said plurality of inputs is associated with a special wildcard input that is associated with zero or one of strokes.

27. The method of claim 1, wherein one of said plurality of inputs is associated with a special wildcard input that is associated with zero or one of said phonetic characters.

28. The method of claim 1, wherein said phonetic indices are indices of phonetic characters sorted by actual spelling in a phonetic input system.

29. A system for receiving input sequences entered by a user and generating textual output in Chinese language, said system comprising:
a user input device having a plurality of input means, each of said input means being associated with a plurality of strokes or phonetic characters, an input sequence being generated each time when an input is selected by said user input device;
an input method specific database containing a plurality of input sequences and, associated with each input sequence, a set of phonetic sequences whose spellings correspond to the input sequence or a set of strokes sequences corresponding to the input sequence;
an ideographic database containing a set of ideographic character sequences, wherein each ideographic character contains an ideographic index, a plurality of stroke indices to corresponding stroke sequences and a plurality of phonetic indices to corresponding phonetic sequences;
means for comparing the input sequence with said input method specific database and finding indices to matching strokes entries or phonetic entries and said matching stroke entries or phonetic entries;
means for converting said matching indices to stroke entries or phonetic entries to matching ideographic indices;
means for retrieving matching ideographic character sequences from said ideographic database by said matching ideographic indices; and
an output device for displaying one or more matched stroke or phonetic entries, and matched ideographic characters.

30. The method of claim 28, wherein said stroke indices are indices of strokes sorted by stroke sequences in a stroke input system.

31. The system of claim 29, wherein said stroke input system is 5-stroke or 8-stroke system.

32. The system of claim 28, wherein said phonetic indices are indices of phonetic characters sorted by actual spelling in a phonetic input system.

33. The system of claim 31, wherein said phonetic input system is a Pinyin system or a Zhuyin system.

34. The system of claim 28, wherein said phonetic indices are indices of input means in a phonetic input system.

35. The system of claim 28, further comprising:
means for prioritizing stroke or phonetic sequences that match an input sequence and prioritizing ideographic character sequences that match a matching stroke or phonetic sequence according to a linguistic model.

36. The system of claim 34, wherein said linguistic model comprises at least one of:
number of total keystrokes in an ideograph;
radical of an ideograph;
radical and number of strokes of radical;
alphabetical order;
frequency of occurrence of ideographic character sequences, stroke sequences or phonetic sequences in formal or conversational written text;
frequency of occurrence of ideographic character sequences, stroke sequences or phonetic sequences when following a preceding character or characters;
grammar of the surrounding sentence;
application context of current input sequence entry; and
recency of use or repeated use of stroke, phonetic or ideographic character sequences by the user or within an application program.

37. The system of claim 28, wherein said phonetic sequences comprise single syllables.

38. The system of claim 28, wherein said phonetic sequences comprise both single and multiple syllables.

39. The system of claim 28, wherein said phonetic sequences comprise user generated sequences.

40. The system of claim 38, wherein in absence of matching phonetic sequences in said database, a sequence of matching phonetic sequences is automatically generated based on single and optionally multiple syllable phonetic sequences.

41. The system of claim 39, wherein said sequence of matching phonetic sequences is narrowed down through user interaction.

42. The system of claim 39, wherein a sequence of matching ideographic character sequences is automatically generated based on matching phonetic sequences to ideographic character sequences.

43. The system of claim 41, wherein a sequence of matching ideographic character sequences is narrowed down through user interaction.

44. The system of claim 34, further comprising:
means for changing the associated priority of the matching phonetic sequence and the sequence of ideographic characters once an ideographic character sequence is selected.

45. The system of claim 28, wherein the user can specify a particular tone for the phonetic syllable.

46. The system of claim 28, wherein one of said plurality of inputs is associated with a special wildcard input that is associated with any or all tones.

47. The system of claim 28, wherein the user can specify an explicit ideographic character separator.

48. The system of claim 28, wherein once the user enters a sequence of phonetic characters, the user is returned a sequence of phonetic sequences of exact matches and predictions that partially match.

49. The system of claim 47, wherein the sequence is ordered according to the frequency of use based on a linguistic model.

50. The system of claim 48, wherein said linguistic model comprises at least one of:
number of total keystrokes in an ideograph;
radical of an ideograph;
radical and number of strokes of radical;
alphabetical order;
frequency of occurrence of phonetic sequences or ideographic character sequences in formal or conversational written text;
frequency of occurrence of phonetic sequences or ideographic when following a preceding character or characters;
grammar of the surrounding sentence;
application context of current character sequence entry; and
recency of use or repeated use of phonetic sequences by the user or within an application program.

51. The system of claim 28, wherein once the user has selected a sequence of ideographic characters, the user is presented with a list of sequences of one or more ideographic characters.

52. The system of claim 50, wherein said list of sequences is ordered according to the frequency of use based on a linguistic model.

53. The system of claim 51, where said linguistic model comprises at least one of:
number of total keystrokes in an ideograph;
radical of ideograph;
radical and number of strokes of radical;
alphabetical order;
frequency of occurrence of ideographic characters in formal or conversational written text;
frequency of occurrence of ideographic characters when following a preceding character or characters;
grammar of the surrounding sentence;
application context of current character entry; and
recency of use or repeated use of ideographic characters by the user or within an application program.

54. The system of claim 28, wherein one of said plurality of inputs is associated with a special wildcard input that is associated with zero or one of strokes.

55. The system of claim 28, wherein one of said plurality of inputs is associated with a special wildcard input that is associated with zero or one of said phonetic characters.

56. A computer usable medium containing instructions in computer readable form for carrying out a process for Chinese text entry, said process comprising the steps of:
(a) entering an input sequence into a user input device;
wherein said user input device comprises:
a plurality of input means, each of said input means being associated with a plurality of strokes or phonetic characters, and an input sequence being generated each time when an input is selected by said user input device;
data consisting of a plurality of input sequences and, associated with each input sequence, an input method specific database containing a plurality of input sequences and, associated with each input sequence, a set of phonetic sequences whose spellings correspond to the input sequence or a set of strokes sequences corresponding to the input sequence; and
an ideographic database containing a set of ideographic character sequences, wherein each ideographic character contains an ideographic index, a plurality of stroke indices to corresponding stroke sequences and a plurality of phonetic indices to corresponding phonetic sequences;
(b) comparing the input sequence with said input method specific database and finding indices to matching strokes entries or phonetic entries and said matching stroke entries or phonetic entries;
(c) converting said matching indices to stroke entries or phonetic entries to matching ideographic indices;
(d) retrieving matching ideographic character sequences from said ideographic database by said matching ideographic indices; and
(e) optionally displaying one or more of said matched ideographic character sequences.

57. The medium of claim 55, wherein said stroke indices are indices of strokes sorted by stroke sequences in a stroke input system.

58. The medium of claim 56, wherein said stroke input system is a five-stroke or an eight-stroke system.

59. The medium of claim 55, wherein said phonetic indices are indices of phonetic characters sorted by actual spelling in a phonetic input system.

60. The medium of claim 58, wherein said phonetic input system is a Pinyin system or a Zhuyin system.

61. The medium of claim 55, wherein said phonetic indices are indices of input means in a phonetic input system.

62. The medium of claim 55, wherein the process further comprises the step of:
prioritizing stroke or phonetic sequences that match an input sequence and prioritizing ideographic character sequences that match a stroke or phonetic sequence according to a linguistic model.

63. The medium of claim 61, wherein said linguistic model comprises at least one of:
number of total keystrokes in an ideograph;
radical of an ideograph;
radical and number of strokes of a radical;
alphabetical order;
frequency of occurrence of ideographic character sequences, stroke sequences or phonetic sequences in formal, conversational written, or conversational spoken text;
frequency of occurrence of ideographic character sequences, stroke sequences or phonetic sequences when following a preceding character or characters;
grammar of the surrounding sentence;
application context of current input sequence entry; and
recency of use or repeated use of stroke, phonetic or ideographic character sequences by the user or within an application program.

64. The medium of claim 55, wherein said phonetic sequences comprise single syllables.

65. The medium of claim 55, wherein said phonetic sequences comprise single and multiple syllables.

66. The medium of claim 55, wherein said phonetic sequences comprise user generated sequences.

67. The medium of claim 65, wherein in absence of matching phonetic sequences in said database, a sequence of matching phonetic sequences is automatically generated based on single and optionally multiple syllable phonetic sequences.

68. The medium of claim 66, wherein said sequence of matching phonetic sequences is narrowed down through user interaction.

69. The medium of claim 66, wherein a sequence of matching ideographic character sequences is automatically generated based on matching phonetic sequences to ideographic character sequences.

70. The medium of claim 68, wherein a sequence of matching ideographic character sequences is narrowed down through user interaction.

71. The medium of claim 61, wherein the process further comprises the step of:
once an ideographic character sequence is selected, changing the associated priority of said matching phonetic sequence and sequence of ideographic characters.

72. The medium of claim 55, wherein the user can specify an explicit ideographic character separator.

73. The medium of claim 55, wherein the process further comprises the step of:
when the user enters a sequence of phonetic characters, returning a sequence of phonetic sequences of exact matches and predictions that partially match.

74. The medium of claim 72, wherein said sequence of phonetic sequences is ordered according to a linguistic model.

75. The medium of claim 73, wherein said linguistic model comprises at least one of:
number of total keystrokes in an ideograph;
radical of an ideograph;
radical and number of strokes of radical;
alphabetical order;
frequency of occurrence of phonetic sequences or ideographic character sequences in formal or conversational written text;
frequency of occurrence of phonetic sequences or ideographic when following a preceding character or characters;
grammar of the surrounding sentence;
application context of current character sequence entry; and
recency of use or repeated use of phonetic sequences by the user or within an application program.

76. The medium of claim 55, wherein the process further comprises the step of:
once the user has selected a sequence of ideographic characters, presenting the user with a list of sequences of one or more ideographic characters.

77. The medium of claim 75, wherein said list of sequences is ordered according to a linguistic model.

78. The medium of claim 76, wherein said linguistic model comprises at least one of:
number of total keystrokes in an ideograph;
radical of an ideograph;
radical and number of strokes of radical;
alphabetical order;
frequency of occurrence of ideographic characters in formal or conversational written text;
frequency of occurrence of ideographic characters when following a preceding character or characters;
grammar of the surrounding sentence;
application context of current character entry; and
recency of use or repeated use of ideographic characters by the user or within an application program.

79. The medium of claim 55, wherein the user can enter partial syllables for each of the multiple syllable words.

80. The medium of claim 78, wherein the number of partial keystrokes for each syllable is one.

81. The medium of claim 55, wherein one of said plurality of inputs is associated with a special wildcard input that is associated with zero or one of strokes.

82. The medium of claim 55, wherein one of said plurality of inputs is associated with a special wildcard input that is associated with zero or one of said phonetic characters.
